(19) United States
(12) Patent Application Publication
(10) Pub. No.: US 2010/0142583 A1
(43) Pub. Date: Jun. 10, 2010

(54) System, method, and apparatus for the calibration of analog type thermometers for use in providing temperature quality control in the production of beverage and/or food products

(76) Inventor: Thor Manuel Christensen, Falls Church, VA (US)

Correspondence Address: Kevin A. Nordberg, 1865 Ballenger Avenue, Alexandria, VA, 22314-5763, US

(21) Appl. No.: 12/585,330

(22) Filed: Sep. 11, 2009

Related U.S. Application Data
(60) Provisional application No. 61/096,373, filed on Sep. 12, 2008.

(51) Int. Cl. G01K 15/00

(52) U.S. Cl. 374/1; 374/E15.001

(57) ABSTRACT

An analog thermometer calibration apparatus may comprise a substantially flat piece of steel or other suitably rigid material having at least one hexagonal or appropriately non-circular shaped aperture or opening formed designed to be at least generally complimentary in size and shape to the calibration adjustment member or projection of an analog type thermometer such that the two may engage in a substantially complimentary manner that will permit rotation of the thermometer readout dial and to prevent the relative rotation of the base or lower portion of the analog thermometer connected to a temperature sensing stem probe during the rotation of the analog thermometer dial face during a calibration procedure. A round or other suitably shaped aperture opening may be included to accommodate support and passage of the temperature sensing probe of a more accurate digital type thermometer (or a recently calibrated thermometer of any type) in order to provide a calibration reference temperature reading. The dial of an analog thermometer may be rotated relative to the base and temperature sensing probe stem portion until the temperature indication pointer on the dial face of the analog thermometer substantially equals or matches the reference temperature reading of the digital thermometer reading or the known temperature of the calibration reference liquid without the need to remove, adjust and/or reinsert the analog thermometer into the calibration reference temperature liquid multiple times to perform an accurate analog thermometer temperature readout calibration process on one or a plurality of analog thermometers in a substantially simultaneous manner.

### RELATED APPLICATIONS

This application claims the benefit of priority to U.S. application Ser. No. 61/096,373 filed Sep. 12, 2009 and entitled “SYSTEM AND METHOD FOR BEVERAGE TEMPERATURE QUALITY CONTROL,” inventor Thor Manuel Christensen, the contents of which are incorporated by reference in their entirety herein as put forth below.

### BACKGROUND OF THE INVENTION

1. Field of the Invention

The invention relates generally to a system, method and apparatus for the calibration of temperature sensing instruments. More, specifically the present invention relates to a system, method, and apparatus for the calibration of one or more analog thermometers of the type typically used within the beverage service or restaurant industry during the preparation of edible beverage or food products. Furthermore, the present invention is related to an apparatus which provides for a simplified means to calibrate one or more analog type thermometers in alignment with a reliable known reference temperature provided by means of a liquid having a known reference temperature and/or another nearly simultaneously taken temperature sensing readout from a more accurate temperature measuring device, such as a digital thermometer or another more recently calibrated analog thermometer performed during the calibration process.

2. Description of Related Art

Typically, during the preparation of a heated or temperature regulated beverage or food product, such as in a coffee shop or restaurant, hot beverages or food items must be served within a predefined range of temperature tolerance. The range of temperature tolerance for a particular beverage or food product may be determined for health and safety reasons, and/or in order to meet a production facility's quality assurance goals. When a beverage service employee, cook or the like are preparing a heated beverage or food product, the temperature, especially of a heated beverage such as steamed milk, is typically measured using an analog type thermometer to ensure it falls within a predefined temperature range to ensure quality and prevent the possibility of food borne illness or the possibility of scalding a patron. Determining the beverage temperature generally includes the placement of the sensing stem or probe of a known analog thermometer within a pitcher or other suitable container used to prepare the beverage. Over the course of a typical business day, an analog thermometer may become uncalibrated wherein the reliability of a temperature reading from one or any of a likely plurality of analog thermometers in regular daily use become less accurate.

In an environment, such as a coffee shop, diner or the like, the volume of heated beverage preparation is typically chaotic and results in thermometers being lifted in and out of pitchers and containers, moved from one pitcher or container to another, placed down upon and picked up from a variety of surfaces, rinsed, wiped with wash cloths, etc. in an environment quickly and frequently changing in temperature. Thus any one of the analog thermometers in regular use at a given facility may become uncalibrated during use and require periodic recalibration to ensure more accurate temperature readings. Recalibration may be performed using a reliable reference temperature liquid, such as an ice bath, or using a more recently calibrated and/or reliable temperature measuring device, such as a digital thermometer. Regular recalibration additionally helps to ensure accurate reading during scheduled or possible surprise inspections by local health department officials. The accuracy of temperature readings from such thermometers may have a required tolerance of as little as two degrees Fahrenheit, or less.

Known processes for the calibration of an analog type thermometer typically involve submerging the analog thermometer and a digital thermometer into a liquid at or near a known reference temperature, such as an ice bath solution. A person performing the calibration of the analog thermometer compares the temperature readings of the respective thermometers. If the temperature reading of the analog thermometer does not match or equal the temperature reading of the digital thermometer or reference liquid temperature, the analog thermometer is removed from the calibration temperature reference liquid. A person calibrating the analog thermometer turns what is typically a hexagonal shaped adjustment member, such as a nut or protrusion projecting from the lower/bottom face of a thermometer dial in order to rotate the temperature indication pointer on the top face of the dial into alignment with temperature readout indicia on the face of the dial which matches the temperature reading of the digital thermometer or the known reference temperature of the calibration liquid. The temperature readout indicia are typically printed in the Fahrenheit and/or Celsius temperature scales. The adjustment member protrusion from the lower or bottom face of the thermometer dial may be made in any suitable generally non-circular shape, such as a square, octagon, etc, that a suitable tool, such as a wrench or pliers, may be used to adjust the thermometer calibration setting. During the calibration of an analog thermometer, the thermometer typically must be repeatedly resubmerged into an ice bath or calibration temperature reference liquid and the calibration adjustment member is repeatedly adjusted gradually becoming more and more accurately calibrated until the temperature reading of the analog thermometer matches or equals the temperature reading of the digital thermometer and or the known temperature of the calibration liquid reference temperature. As such, known analog thermometer calibration processes are cumbersome, excessively time consuming and requires the person performing the calibration procedure to use both hands while numerous iterations of submerging, removing, and re-submerging an analog thermometer and the digital reference thermometer into the calibration reference temperature liquid for repeated minor adjustments until the proper analog temperature reading is achieved.

In addition to the lengthiness of such known individuals calibration processes, the analog thermometer recalibration process may need to be repeated several times over the course of any given business day in order to ensure consumer safety and product quality. In a typical coffee shop there may be ten or more such analog thermometers in use simultaneously by a plurality of service employees. Therefore, the time and effort required to repeatedly calibrate all analog thermometers in regular use may become extensive and overly burdensome. Further, the excessive time and burden of repeatedly calibrating analog thermometers may lead some service employees to not bother to calibrate the analog thermometers. Not regularly calibrating the analog thermometers in use can lead to the production of poor quality beverage or food products and/or consumer health and safety hazards.

Therefore, there is a need in the art for a method and apparatus to simplify and shorten the time required to perform the calibration process for an analog type thermometer, and to also to permit the simultaneous calibration of a plurality of such analog thermometers. Furthermore, there is a need in the art to provide an apparatus that simplifies the process of producing heated beverages and/or food products that fall within a predefined temperature range in order to ensure the product quality goals of a particular franchise or facility, to comply with health standards and regulations.

### SUMMARY OF THE INVENTION

In view of the above described problems and unmet needs within the related art, the present invention provides for a system, method and apparatus to assist in the calibration of one or more temperature measuring devices, such as an analog thermometer, utilizing a reference temperature readout from a reliable temperature source, such as a regulated temperature calibration reference liquid and/or a temperature reading from a more reliable or more recently calibrated temperature reading device, such as a digital thermometer. Further, the present invention provides for an apparatus and method to provide means to simplify and shorten the time required to quickly, efficiently, and/or simultaneously calibrate one or more analog type thermometers for use in the preparation of beverages and/or food products in order to ensure product quality and/or consumer health and safety because the beverage or food products are to be served within a predefined temperature range.

In one aspect of the present invention the apparatus may comprise a substantially flat piece of steel or other suitably rigid material having at least one hexagonal or appropriately shaped recess, opening or aperture designed to be at least generally complimentary in size and shape to the calibration adjustment member projection of an analog type thermometer such that the two may engage in a substantially complimentary manner that will prevent rotation of the base or lower portion of the analog thermometer during the rotation of the dial of the thermometer during the calibration process. A round or otherwise suitably shaped aperture or opening may be included to accommodate passage of a temperature sensing probe and engagement with a digital type thermometer (or recently calibrated thermometer of any type) in order to provide a calibration reference temperature reading. The dial of an analog thermometer may be rotated until the temperature indication pointer on the face of the thermometer substantially equals or matches the temperature reading of the reference digital thermometer reading or the known temperature of the calibration reference liquid without the need to remove, adjust and reinsert the analog thermometer into the calibration reference temperature liquid multiple times.

In another aspect of the present invention the apparatus may include multiple holes, recesses and/or apertures to accommodate multiple analog thermometers simultaneously. The multiple apertures may all have the same size and shape or may vary in size and shape in order to accommodate different models and sizes of analog thermometers. For example, the apparatus may include three or more hexagonal or other appropriately shaped apertures capable of holding a digital reference thermometer and a plurality of analog thermometers to provide means for the simultaneous calibration of the plurality of analog thermometers.

Additional advantages and novel features of the above-noted aspects of the present invention will be set forth in the following description. These advantages and novel features will in part become more apparent to a person having ordinary skill in the art upon examination of this description and by the practice of the present invention.

### BRIEF DESCRIPTION OF THE DRAWINGS

A more complete appreciation of the invention will be readily obtained as the same becomes better understood by reference to the following detailed description when considered in connection with the accompanying drawings, wherein:

FIG. 1 illustrates an aspect a preferred embodiment of the present invention.

FIG. 2A illustrates an analog thermometer for use in accordance with aspects of the present invention.

FIG. 2B illustrates a known analog thermometer suitable for use in accordance with aspects of the present invention.

FIG.3 illustrates a known digital thermometer for use in accordance with aspects of the present invention.

FIG. 4 illustrates a container and the method and system of calibrating one or simultaneously calibrating a plurality of analog thermometers in accordance with aspects of the present invention.

FIG. 5 illustrates a system and method for the calibration of one or a plurality of analog thermometers in accordance with aspects of the present invention.

### DESCRIPTION OF THE PREFERRED EMBODIMENTS OF THE INVENTION

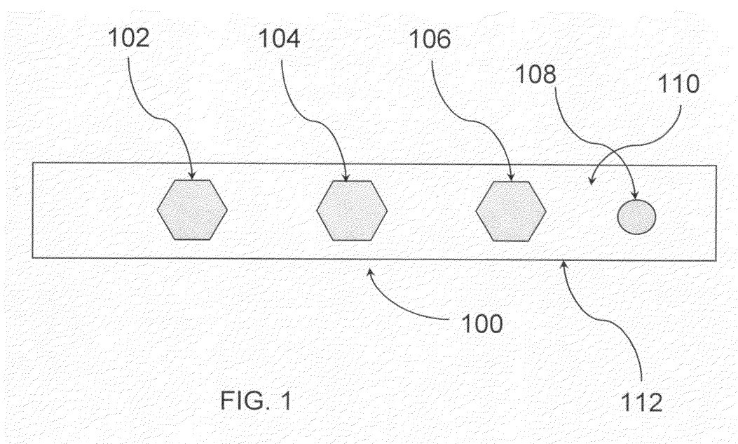

FIG. 1 illustrates apparatus 100 according to an aspect of the present invention. Apparatus 100 may be comprised of a flat piece of suitably strong and rigid material having a top generally flat planar top surface 110 and a bottom similarly shaped bottom planar surface 112. The material of construction of the apparatus of the invention may be any suitable material that is strong, durable, and resistant to a variety of different temperatures, at least within the freezing to boiling point of water or other similar liquid.

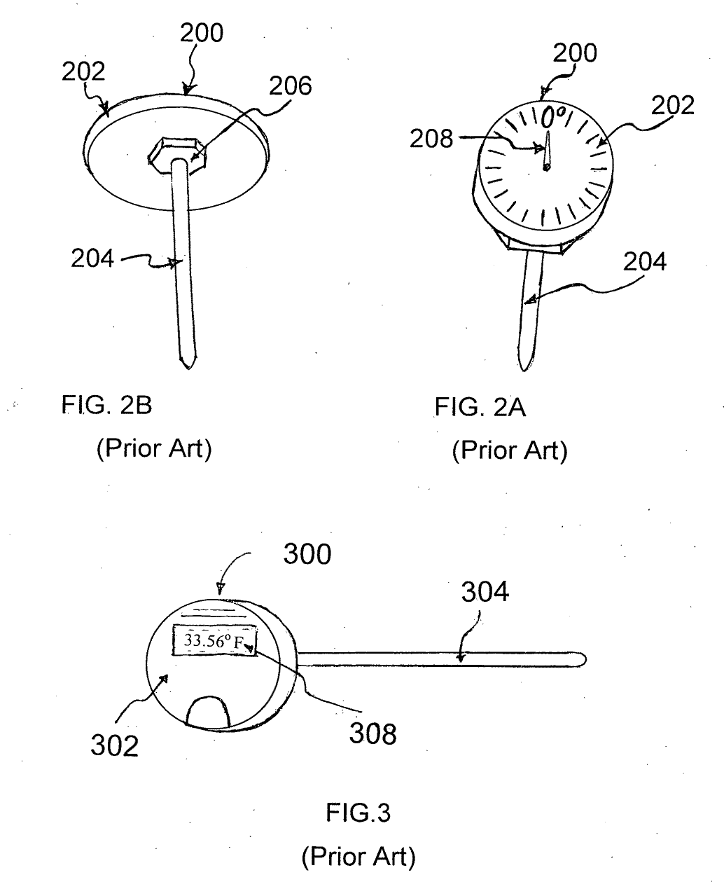

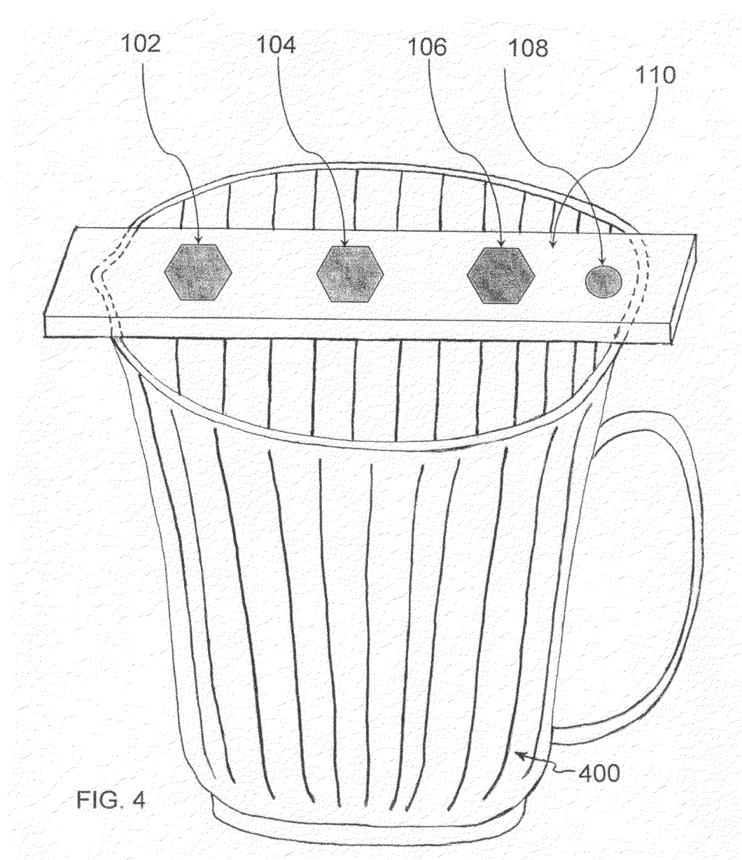

Referring now to the drawings, wherein like reference numerals designate identical or corresponding parts throughout the several views, FIG. 1 illustrates a top view of a preferred embodiment the apparatus 100 of the present invention which may be of various sizes and may include at least one or more apertures of various shape and/or size. For example, apparatus 100 may include apertures 102, 104, 106, and 108, as illustrated in FIG. 1. Apertures 102, 104, and 106 may be formed in a hexagonal or other suitably appropriate shape to accommodate a known traditional analog type thermometer 200, as illustrated in FIG. 2A and FIG. 2B. Aperture 108 may be formed in a circular or other suitably appropriate shape to accommodate a known traditional digital type thermometer or another more recently calibrated reference thermometer 300, as illustrated in FIG. 3. Again, it should be appreciated that apertures 102, 104, 106 and 108 may be formed having various geometrical shapes and sizes that are capable of holding a typical know analog type thermometer in place via complementary engagement with and around the adjustment member or nut of the analog thermometers. For example, the aperture shape may be one or more of a circle, triangle, square, rectangle, oval, hexagon, and/or a nearly unlimited variety of different suitable shapes which are complementary in size and shape to the adjustment member, nut or protrusion of any known analog type thermometers. Moreover, apertures 102, 104, 106, and 108 may be arranged in apparatus 100 in more than one row, such as in a matrix, circle, square, oval or any other suitable arrangement.

FIG. 2A illustrates a typical known analog type thermometer 200 for use in accordance with aspects of the present invention. Analog thermometer 200 includes a temperature readout dial 202 with a temperature pointer or needle 208 and a temperature sensing probe or stem 204. FIG. 2B illustrates a different perspective of analog thermometer 200 from a lower angle. On the side opposite the temperature dial 202 is a hexagonal shaped temperature calibration adjustment nut 206 including a temperature sensing probe or stem 204 passing therethrough to the temperature readout dial 202. A traditional known analog thermometer pointer or needle 208 may be adjusted by rotating the hexagonal shaped adjustment member or nut 206, relative to the temperature indication dial 202. This enables a person to increase or decrease the position of the temperature indication pointer relative to the position of the dial temperature indicia accordingly.

FIG. 3 illustrates a typical known digital type thermometer 300 suitable for use in the present invention. Digital thermometer 300 has a face surface 302, a digital readout 308 for display of a temperature measurement, and a temperature sensing stem or probe 304.

FIGS. 4 illustrate the apparatus, method and system for analog thermometer temperature calibration in accordance with aspects of the present invention, wherein the bottom planar surface 112 of the apparatus 100 rests over the peripheral edges of a pitcher or beverage preparation container 400. It should be appreciated that apparatus 100 may be comprised of various suitable materials and include apertures formed in various suitable shaped and sizes in order to accommodate a variety or variously sized and/or shaped beverage preparation containers. For example, the shape of the apparatus 100 may be any one of a rectangle, square, oval, circle, or any other shape suitable for use with the cross section of any generally cylindrical or bowl shaped container. Moreover, apertures 102, 104, 106, and 108 may be arranged in any number of various positions suitable for the purposes of simultaneous calibration of one or a plurality of thermometers. For example, apertures 102, 104, 106, and 108 may be arranged in a single row, a multiple row matrix, a circle, a square, or a rectangle among as a variety of other suitable arrangements. Further, a container 400 may comprise a pitcher, cup, bowl, jar, can, or any other suitable container capable of holding a temperature reference liquid. In accordance with the present invention, container 400 may be filled with an ice bath or other suitable temperature reference liquid to aid in the calibration of the temperature reading of one or more analog type thermometers 200 using a digital thermometer 300 reference temperature reading or the otherwise know temperature of the reference liquid. It should be appreciated that container 400 may hold any solution capable of aiding in the calibration of analog thermometers.

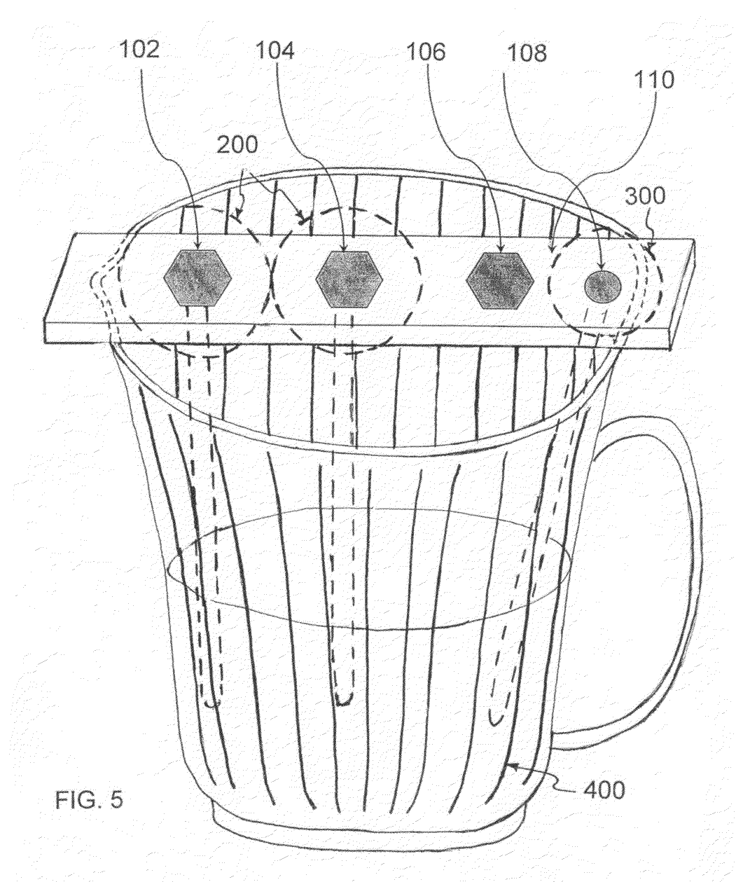

FIG. 5 also illustrates the method and system for thermometer temperature calibration in accordance with aspects of the present invention, wherein the bottom planar surface 112 of the apparatus 100 rests over the peripheral edges of a pitcher or beverage preparation container 400. As illustrated, an analog thermometer 200 and a digital reference thermometer 100 are respectively placed in apertures 102 and 108. Analog thermometer 200 is shown placed in aperture 102 having the temperature sensing stem 204 positioned below the calibration apparatus 100 with the hexagonal calibration adjustment nut in complimentary and secure engagement with aperture 102. The temperature readout dial 202 rests above the top plane 110 or the apparatus of the invention 100. Digital reference thermometer 300 is placed though the aperture and into engagement

If the temperature reading from the temperature indication needle or pointer 208 is different from the temperature reading shown of the display 308 of the digital reference thermometer or the otherwise known temperature of the calibration reference liquid solution, a person may rotate the temperature indication readout dial 202 until the temperature needle or pointer 208 matches or equals the temperature readout of the digital thermometer or otherwise know temperature of the reference liquid. For example, a person may rotate the temperature readout dial 202 to match or equal the known reference temperature readout. Since the hexagonal or otherwise shaped calibration adjustment member or nut 206 is held securely in place by one of the apertures 102, 104, or 106, rotational movement of the temperature readout dial 202 may be utilized to adjust the temperature readout of one or more the temperature indication needle or pointer of an analog thermometer. However, it should be appreciated that any rotational movement of the temperature indication needle or pointer relative to the temperature indication indicia on the face of the temperature indication readout dial 202 to ensure an accurate temperature dial readout from the one or more analog thermometers, as shown by the temperature indication needle or pointer 208 may be used. This allows for the person performing the temperature reading calibration of the one or more analog thermometers may be used. Thus, the person performing the calibration procedure on the one or more analog thermometers 200 may complete the calibration process without the need to remove the one or more analog thermometers 200 from the ice bath or other temperature reference liquid solution. Further, the apparatus of the invention provides means for a person to adjust the calibration of the one or more analog thermometers using only one hand.

Many additional modifications and variations of the apparatus and method for the calibration of analog type thermometers of the present invention are possible in light of the above teachings. While the invention has been described in conjunction with the aspects of the present invention outlined above, various alternatives, modifications, variations, improvements, and/or substantial equivalents, whether known or that are or may be presently unforeseen, may become apparent to a person having ordinary skill in the related art. Accordingly, the aspects of the present invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed as new and is desired to be secured by Letters Patent of the United States is:

1. An apparatus for the calibration of one or more analog thermometers including a temperature readout dial with a temperature readout pointer and temperature readout indicia printed on the face of said dial, a temperature sensing probe, a temperature readout calibration adjustment member rotatable, relative to said temperature readout dial, having a generally non-circular shaped cross section, said probe having a stem portion and/or a tip portion disposed opposite to said face of said temperature readout dial, the calibration apparatus comprising:
a generally flat shaped body of a suitably strong, rigid, and durable material of sufficient length to extend across the top peripheral edge of a container having a predefined size and shape in order to support said calibration apparatus above the surface of a temperature reference liquid placed within said container whose temperature may be simultaneously determined using a known reference liquid temperature falling within a predefined temperature range, wherein
said one or more generally non-circular cross-section shaped apertures are formed having at least a generally complimentary shape and size relative to the temperature adjustment members of said one or more analog thermometers so that said calibration apparatus apertures are able to accommodate placement of said one or more analog thermometers within said apparatus apertures while said temperature sensing probes and stems or tips come into physical contact with said temperature reference liquid temperature to provide for means to take a temperature readout for said one or more analog thermometer temperature readout dials; such that said faces of said temperature indication dials of said one or more analog temperature thermometers may be manually rotated in order such that said temperature indication pointers are moved into alignment said thermometer readout dial temperature indicia and are set to be substantially equal to said temperature readout of said digital thermometer, a more recently calibrated analog thermometer, or a known temperature value of the temperature indication reference liquid, without the need to remove, adjust and/or reinsert the analog thermometer into contact with the calibration reference temperature liquid multiple times.

2. An apparatus for the calibration of one or more analog type thermometers of claim 1, wherein said know temperature reference liquid temperature readout is provided by more a accurate digital type thermometer, a more recently calibrated analog thermometer, or otherwise know temperature reference liquid temperature, such as an ice bath.

3. An apparatus for the calibration of one or more analog type thermometers of claim 1, wherein said non-circular cross-section shapes of said calibration apparatus apertures may be one of a hexagon, oval, square, slotted edge, or other suitable shape at least generally complimentary in size and shape of any analog thermometer dial calibration adjustment member.

4. An apparatus for the calibration of one or more analog type thermometers of claim 1, wherein the calibration apparatus material of construction may be one or more of a metal, wood, plastic, or other suitable combination of sufficiently strong, rigid, and durable materials.

5. A method for the calibration of one or more analog thermometers including a temperature readout dial with a temperature readout pointer and temperature readout indicia printed on the face of said temperature readout dial, a temperature sensing probe, a temperature calibration adjustment member, rotatable relative to said temperature readout dial, having a generally non-circular shaped cross section extending from and connected to a lower side of said dial opposite the dial face temperature readout side, said probe having a stem portion or a tip portion, utilizing a calibration apparatus having a generally flat shaped body comprised of a suitably strong and rigid material of sufficient length to extend across the peripheral edge of a container in order to support said calibration apparatus above the surface of a known temperature reference liquid placed within said container, said temperature reference liquid temperature falling within a predefined temperature range, the method comprising the steps of:
placing said calibration apparatus over the top of said container;
placing said one or more an analog thermometers temperature sensing probe stem and/or tip portions through one of said generally noncircular shaped aperture of said calibration apparatus such that the aperture and said calibration adjustment member of said at least one analog thermometer are supported and in an at least generally complementary position for engagement with said apertures;
manually rotating said dial face of said one or more analog thermometers so that said temperature dial pointer rotated into alignment with the temperature indicia printed on the dial face of said temperature indication dial is substantially equal to the known temperature of the reference temperature liquid in said container, as indicated by the temperature readout or a digital thermometer, more recently calibrated analog thermometer, or the otherwise known temperature value of the calibration reference temperature liquid.

6. A method for the calibration of one or more analog type thermometers of claim 5, wherein said known temperature reference liquid temperature is readout from a more accurate digital type thermometer, a more recently calibrated analog thermometer, or an otherwise know temperature reference liquid, such as an ice bath, wherein the manual rotation of the temperature readout dial or the one or more analog thermometers for rotating the temperature readout indication pointer relative to the analog thermometer temperature indication dial indicia into calibration the temperature of the known reference temperature readout without the need to remove and replace the temperature sensing probes, stems, or tips of the one or more analog thermometers into and out of contact with the known temperature reference liquid multiple times.

7. A method for the calibration of one or more analog type thermometers of claim 5, wherein said known temperature reference liquid temperature readout is taken from a more accurate digital thermometer, a more recently calibrated analog thermometer, or an otherwise known temperature reference liquid temperature, such as an ice bath, substantially simultaneously with the manual rotation of the temperature readout dial or the one or more analog thermometers for calibration of the analog thermometer temperature readouts to equal the known reference temperature.

8. A system for improving the provisional of temperature quality control in the production of beverages or food products by providing means for decreasing the time required for the calibration of a plurality of analog thermometers wherein one or more analog thermometers including a temperature readout dial with a temperature readout pointer and temperature readout indicia printed on the face of said dial, a temperature sensing probe, a temperature calibration adjustment member, rotatable relative to said temperature readout dial, having a generally non-circular shaped cross section, said probe having a stem portion and a tip portion disposed opposite to said face of said temperature readout dial, are supported by a generally flat shaped body of a suitably strong, rigid, and durable material of sufficient length and extended across the peripheral edge of a container having a predefined size and shape in order to in order to support said calibration apparatus above the surface of a temperature reference liquid placed within said container whose temperature is a known reference liquid temperature falling within a predefined temperature range, wherein said temperature sensing probe stems and tips of said one or more analog thermometers are placed through and the calibration adjustment members are engaged in a complimentary to prevent rotation of the adjustment members relative to said calibration apparatus so that the dial faces of said one or more analog thermometers may be manually rotated relative to the temperature sensing probes to move said temperature indication pointers into calibration alignment so that the temperature readout of said one or more analog thermometers to equal said known temperature of said temperature reference liquid.

9. A system for improving the means to provide for temperature quality control in the production of beverages or food products of claim 8, wherein means to readout said known temperature reference liquid temperature may comprise a more accurate digital type thermometer, a more recently calibrated analog thermometer, or an otherwise know temperature reference liquid, such as an ice bath, wherein means also are provided to enable the manual rotation of the temperature readout dial or the one or more analog thermometers for rotating the temperature readout indication pointer relative to the analog thermometer temperature indication dial indicia into calibration the temperature of the known reference temperature readout without the need to remove and replace the temperature sensing probes, stems, or tips of the one or more analog thermometers into and out of contact with the known temperature reference liquid multiple times.

10. A system for improving the means to provide for temperature quality control in the production of beverages or food products of claim 8, wherein means to provide said known temperature reference liquid temperature readout may comprise a more accurate digital thermometer, a more recently calibrated analog thermometer, or an otherwise known temperature reference liquid temperature, such as an ice bath, means for the manual rotation of the temperature readout dial or the one or more analog thermometers for calibration of the analog thermometer temperature readouts to equal the known reference temperature in a substantially simultaneous manner.
